(19) United States
(12) Patent Application Publication
(10) Pub. No.: US 2006/0225553 A1
(43) Pub. Date: Oct. 12, 2006

(54) Disk cutter having tip inserts coated with a hard material

(75) Inventors: Seiichi Hasegawa, Fukuroi (JP); Junichi Tanifuji, Fukuroi (JP)

Correspondence Address: RADER FISHMAN & GRAUER PLLC, LION BUILDING, 1233 20TH STREET N.W., SUITE 501, WASHINGTON, DC, 20036, US

(73) Assignee: Tenryu Seikyo Kabushiki Kaisha

(21) Appl. No.: 11/366,594

(22) Filed: Mar. 3, 2006

(30) Foreign Application Priority Data
Apr. 12, 2005 (JP) 2005-114360

(51) Int. Cl. B23D 57/00

(52) U.S. Cl. 83/835

(57) ABSTRACT

A disk cutter including an annular disk-shaped base adapted to be driven about an axis of rotation, a plurality of tip supports formed along the outer circumference of the base integrally therewith so that a gullet is defined between adjacent ones of the tip supports, a plurality of tip inserts respectively fixed to the tip supports, and a TiAlN coating formed on the surface of each tip insert. Each tip insert is formed of a sintered alloy composed of 98 to 90 w % of WC powder having a particle size of 0.1 to 0.8 μm and 2 to 10 w % of Co powder. The TiAlN coating has a thickness of 1 to 5 μm.

### BACKGROUND OF THE INVENTION

1. Field of the Invention

The present invention relates generally to a disk cutter, and more particularly to a disk cutter or circular saw suitable for cutting of steel such as stainless steel.

2. Description of the Related Art

A disk cutter or circular saw including a base disk having a plurality of tip supports arranged along the outer circumference and a plurality of hardened cutting tip inserts (cutter inserts) respectively fixed to the tip supports by brazing or the like is frequently used for cutting of steel or the like. The tip supports are spaced at given intervals in the circumferential direction of the base disk or annular disk-shaped base, and a gullet is defined between adjacent ones of the tip supports.

Each tip support has a recess, and each cutting tip insert is fixed in the recess of the corresponding tip support by brazing or the like. The base disk has a mounting hole at its central portion, and a rotating shaft of a rotary tool is inserted through the mounting hole of the base disk. The disk cutter is fastened to the rotating shaft by a bolt to thereby mount the disk cutter to the rotary tool. In cutting steel by using such a disk cutter, the hardness and wear resistance of each tip insert must be increased. It is considered that each tip insert is coated with a hard material such as TiN and TiAlN by a physical vapor deposition including ion plating as proposed in JP2000-233320 and JP2000-233324.

However, in such a disk cutter that the surface of each tip insert is simply coated with a hard material, the adhesion of the hard material to the surface of each tip insert is insufficient. Accordingly, when steel such as stainless steel is cut for a long time by using this disk cutter, there is a case that the hard material may separate from the surface of each tip insert, thus causing a problem in durability of the disk cutter.

### SUMMARY OF THE INVENTION

It is therefore an object of the present invention to provide a disk cutter which can improve the adhesion of a hard material to the surface of each tip insert, thereby extending the life.

In accordance with an aspect of the present invention, there is provided a disk cutter including an annular disk-shaped base adapted to be driven about an axis of rotation; a plurality of tip supports formed along the outer circumference of the base integrally therewith so that a gullet is defined between adjacent ones of the tip supports; a plurality of tip inserts respectively fixed to the tip supports; and a TiAlN coating formed on the surface of each tip insert; each tip insert being formed of a sintered alloy composed of 98 to 90 w % of WC powder having a particle size of 0.1 to 0.8 μm and 2 to 10 w % of Co powder; the TiAlN coating having a thickness of 0.5 to 5 μm.

The TiAlN coating may be replaced by a TiAlN—TiN coating formed by alternately stacking TiN layers and TiAlN layers on the surface of each tip insert.

As described above, each tip insert is formed of a sintered alloy composed of 98 to 90 w % of WC powder having a particle size of 0.1 to 0.8 μm and 2 to 10 w % of Co powder. Accordingly, the adhesion of the TiAlN coating or the TiAlN—TiN coating to each tip insert can be greatly improved. As a result, it is possible to prevent that the coating may separate from the surface of each tip insert, so that it is possible to provide a disk cutter suitable for cutting of steel such as stainless steel which can improve the wear resistance and the service life.

The above and other objects, features and advantages of the present invention and the manner of realizing them will become more apparent, and the invention itself will best be understood from a study of the following description and appended claims with reference to the attached drawings showing some preferred embodiments of the invention.

### BRIEF DESCRIPTION OF THE DRAWINGS

FIG. 1 is a side view of a disk cutter according to a preferred embodiment of the present invention;

FIG. 2 is an enlarged view of a part of an outer circumferential portion of the disk cutter including tip inserts;

FIG. 3A is an elevational view of a first kind of tip insert shown in FIG. 2;

FIG. 3B is a right side view of the tip insert shown in FIG. 3A;

FIG. 3C is a plan view of the tip insert shown in FIG. 3A;

FIG. 4 is a right side view similar to FIG. 3B, showing a second kind of tip insert shown in FIG. 2;

FIG. 5 is an enlarged sectional view of the first kind of tip insert on which a TiAlN coating is formed;

FIG. 6 is an enlarged sectional view of the first kind of tip insert on which a TiAlN—TiN coating is formed; and

FIG. 7 is a schematic diagram of a coating forming apparatus.

### DETAILED DESCRIPTION OF THE PREFERRED EMBODIMENTS

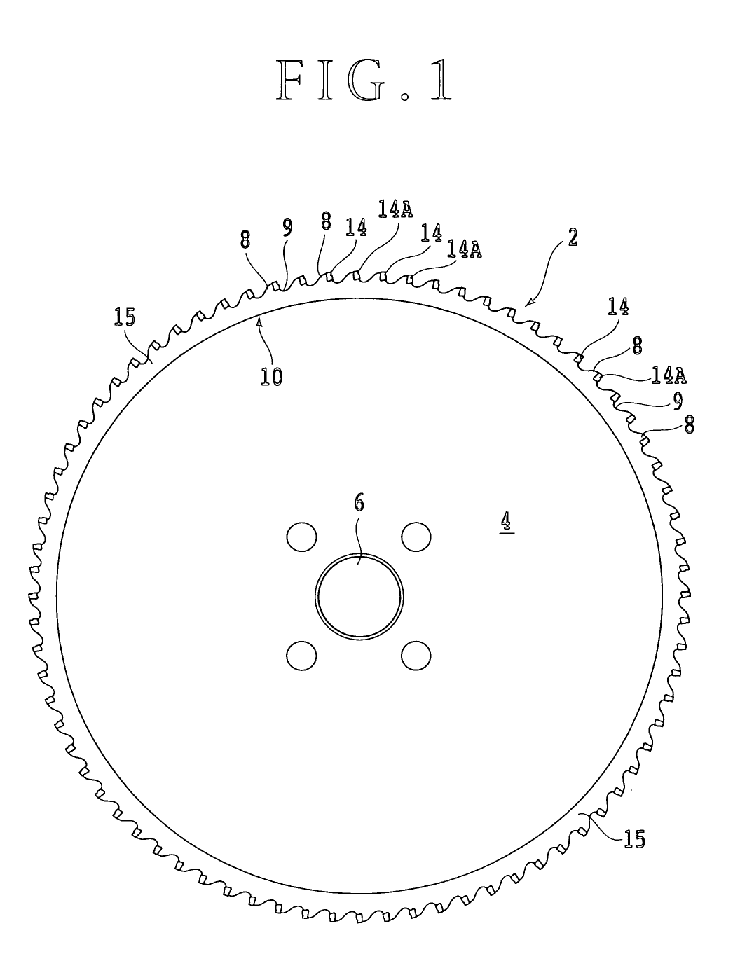

Referring to FIG. 1, there is shown a side view of a disk cutter 2 according to a preferred embodiment of the present invention. The disk cutter 2 is suitable for cutting of steel such as austenitic stainless steel, ferritic stainless steel, and martensitic stainless steel. The disk cutter 2 includes an annular disk-shaped base (base disk) 4 having a thickness of about 1.7 mm and a plurality of (e.g., 72) saw-toothed tip supports 8 formed along the outer circumference of the base disk 4 at equal intervals. A gullet 9 is defined between adjacent ones of the tip supports 8. The base disk 4 is formed of steel such as JIS SKS5 (alloy tool steel), JIS SK5 (carbon tool steel), or JIS SK6 (carbon tool steel). The diameter of the base disk 4 is about 250 mm, for example, and the base disk 4 has a central hole 6 having a diameter of about 32 mm, for example. However, these values are merely illustrative, and the disk cutter of the present invention is not limited to this preferred embodiment.

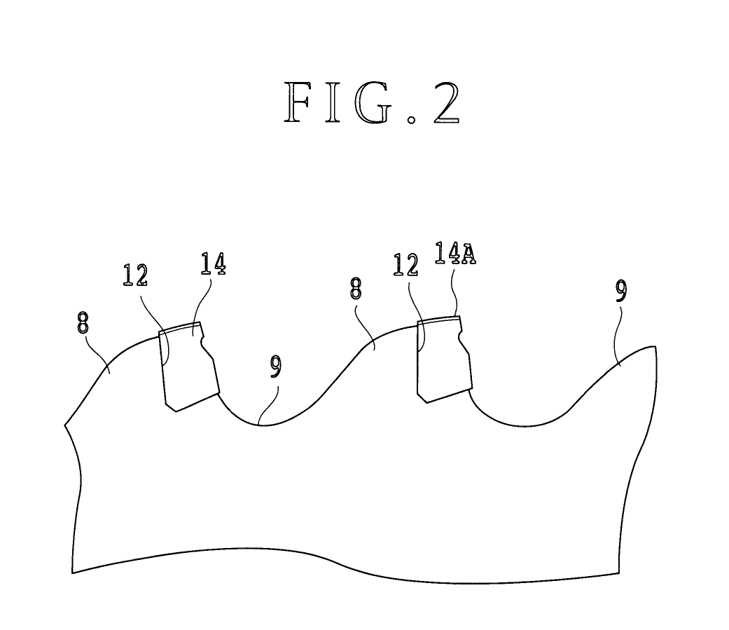

As shown in FIG. 2, each tip support 8 is formed with a recess 12, and a plurality of tip inserts 14 and 14A are fixed in the recesses 12 of the plural tip supports 8 by brazing or the like. As hereinafter described in detail, the tip inserts 14 and 14A are different from each other in position of a chip splitting groove, and they are alternately brazed to the tip supports 8. Each of the tip inserts 14 and 14A is mainly formed of a sintered alloy composed of WC powder and Co powder. The Co powder functions as a binder. To improve the adhesion of a coating to be formed on the surface of each tip support, the WC powder preferably has a particle size of 0.1 to 0.8 μm. If the particle size of the WC powder is greater than 0.8 μm, the surface of each tip insert becomes unsmoothed and the adhesion of the coating to be formed on the surface of each tip insert is therefore degraded.

Preferably, each of the tip inserts 14 and 14A is formed of a sintered alloy composed of 98 to 90 w % of WC powder having a particle size of 0.1 to 0.8 μm and 2 to 10 w % of Co powder. More preferably, each of the tip inserts 14 and 14A is formed of a sintered alloy composed of 5 to 8 w % of Co powder and a remaining amount of WC powder having a particle size of 0.1 to 0.8 μm. A forming method for the sintered alloy is well known in the art, so the description thereof will be omitted herein.

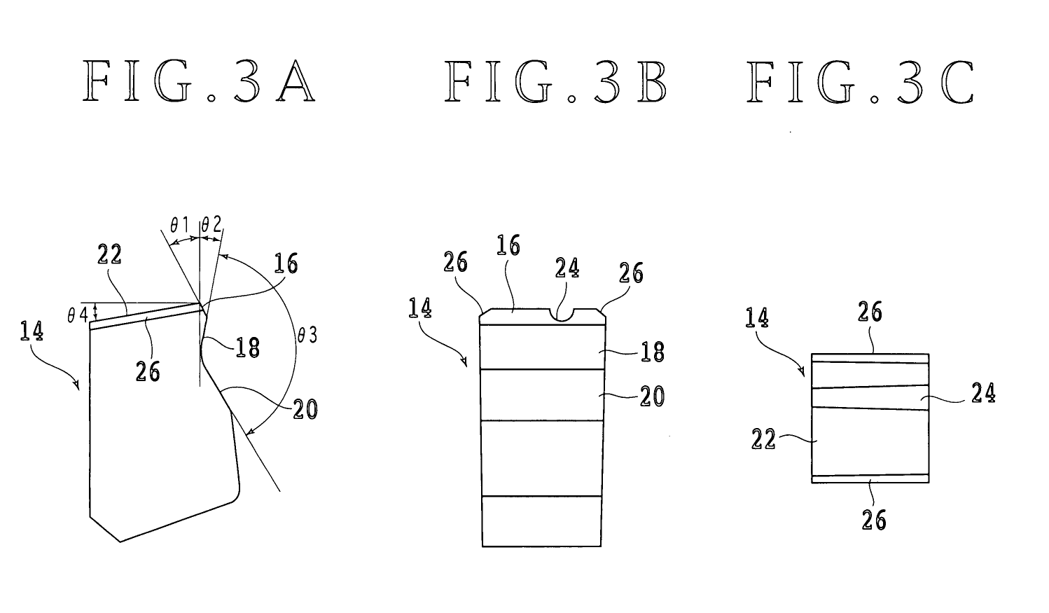

FIG. 3A is an elevational view of each tip insert 14. FIGS. 3B and 3C are a right side view and a plan view of each tip insert 14 shown in FIG. 3A, respectively. As shown in FIG. 3A, each tip insert 14 has a first face 16 having a first rake angle θ1, a second face 18 having a second rake angle θ2, and a chip guiding surface 20 having a guide angle θ3. For example, the first rake angle θ1 is −30°, the second rake angle θ2 is +10°, and the guide angle θ3 is 135°. Further, each tip insert 14 has a flank 22 having a clearance angle θ4. For example, the clearance angle θ4 is about 10°. Although not especially shown, each tip insert 14 has a side clearance angle of about 1° and a side centripetal angle of about 1°.

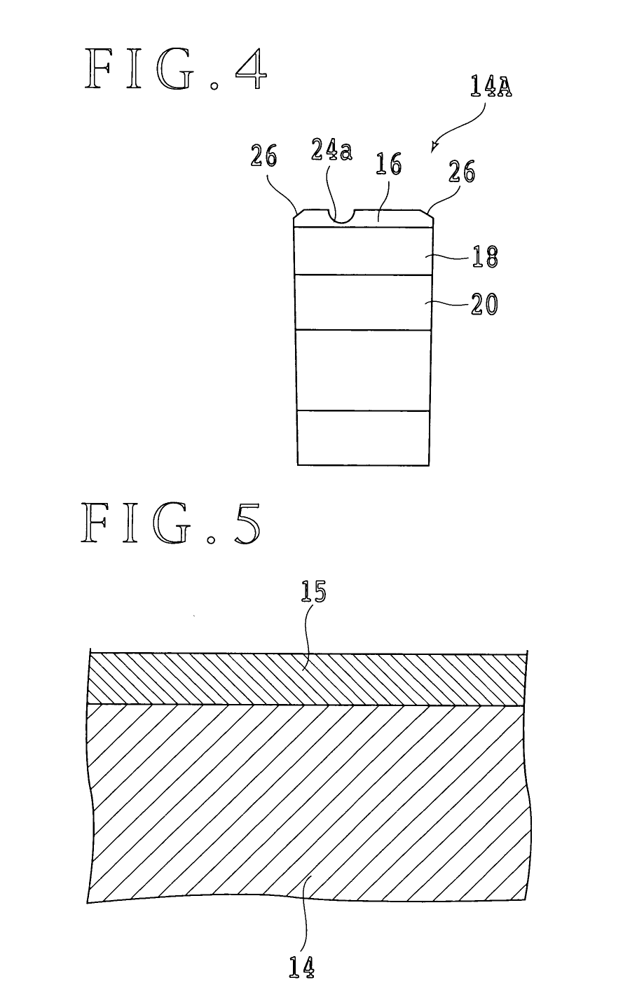

As shown in FIGS. 3B and 3C, the flank 22 of each tip insert 14 is formed with a chip splitting groove 24 extending along a transversely central line on the flank 22 at a position transversely deviated from this central line. As shown in FIG. 4, each tip insert 14A secured to the tip supports 8 alternately with the tip insert 14 similarly has a chip splitting groove 24a transversely deviated from the central line in a direction opposite to that of deviation of the chip splitting groove 24. In this manner, the tip inserts 14 and 14A have the respective chip splitting grooves 24 and 24a transversely deviated from the central line in the opposite directions, so that a chip can be split in the transversely opposite directions in cutting a work material.

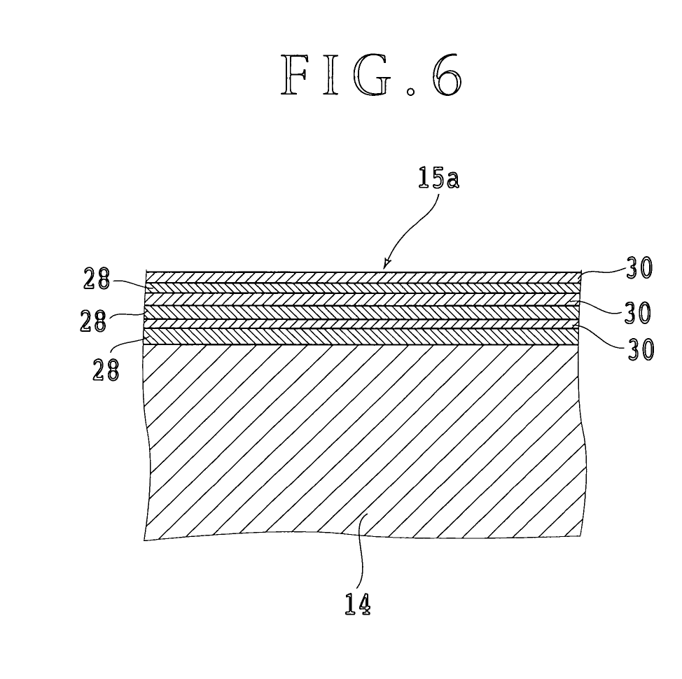

Referring again to FIG. 1, a TiAlN coating 15 is formed on an outer circumferential portion of the disk cutter 2 including the tip inserts 14 and 14A, which portion is a portion radially outside of a circle shown by reference numeral 10. The TiAlN coating 15 may be replaced by a TiAlN—TiN coating 15a (see FIG. 6).

FIG. 5 is an enlarged sectional view of each tip insert 14 on which the TiAlN coating 15 is formed. The TiAlN coating 15 is formed by ion plating, for example, on the surface of each tip insert 14 formed of a sintered alloy composed of WC powder and Co powder. The coating 15 has a hardness of about 3,000 to 4,000 Hmv, so that it has excellent wear resistance and cohesion resistance. Further, since each tip insert 14 is formed of a sintered alloy composed of WC powder having a particle size of 0.1 to 0.8 μm and Co powder, a very high adhesion of about 80 N (Newton) or more of the coating 15 to each tip insert 14 can be obtained. The thickness of the TiAlN coating 15 is set to 1 to 5 μm, preferably 2 to 3.5 μm.

FIG. 6 is an enlarged sectional view of each tip insert 14 on which the TiAlN—TiN coating 15a is formed according to another preferred embodiment of the present invention. The TiAlN—TiN coating 15a having a thickness of 1 to 5 μm is formed by ion plating, for example, on the surface of each tip insert 14. Preferably, the thickness of the TiAlN—TiN coating 15a is set to 2 to 3.5 μm. The TiAlN—TiN coating 15a is composed of multiple TiN layers 28 and multiple TiAlN layers 30 alternately stacked. Preferably, the lowermost layer of the coating 15 formed on the surface of each tip insert 14 is provided by the TiN layer 28, and the uppermost layer of the coating 15a is provided by the TiAlN layer 30. Also in this preferred embodiment, each tip insert 14 is formed of a sintered alloy composed of WC powder and Co powder having a particle size of 0.1 to 0.8 μm. Accordingly, a very high adhesion of about 80 N or more of the coating 15a to each tip insert 14 can be obtained.

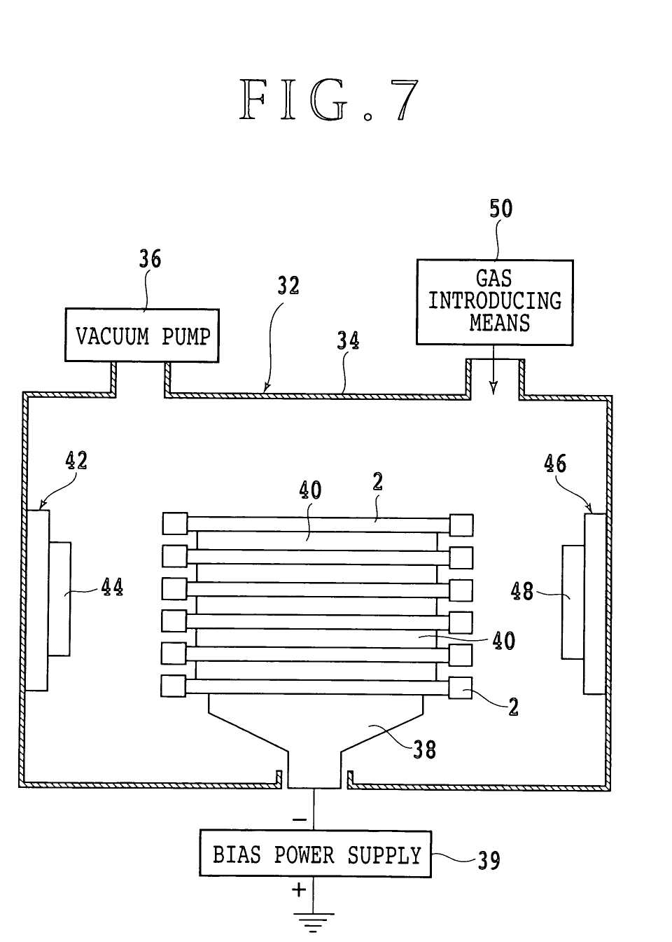

A forming method for the TiAlN—TiN coating 15a will now be described with reference to FIG. 7. Reference numeral 32 generally denotes a coating forming apparatus having a chamber 34. A vacuum pump 36 is provided so as to communicate with the chamber 34, thereby evacuating the chamber 34 to obtain a vacuum condition in the chamber 34. A table 38 is provided in the chamber 34 so as to be rotatable by driving means (not shown). The table 38 is removable from the chamber 34. The table 38 is connected to a bias power supply 39, so that a bias voltage of 0 to −150 V, for example, is applied to the table 38.

A plurality of disk cutters 2 are placed on the table 38 in such a manner that they are stacked with a plurality of disk-shaped spacers 40 alternately interposed therebetween. Each disk cutter 2 has the above-mentioned structure that the tip inserts 14 and 14A are brazed to the tip supports 8. A first evaporation source 42 and a second evaporation source 46 are provided in the chamber 34. The first evaporation source 42 has a Ti target 44 to generate and supply Ti ions. The second evaporation source 46 has a TiAl target 48 to generate and supply Ti ions and Al ions at the same time. Further, gas introducing means 50 is provided to introduce a reactive gas such as N₂ gas and an etching gas such as Ar gas into the chamber 34. Although not especially shown, heating means such as a heater is provided in the chamber 34 to heat the inside thereof.

A coating forming method by the coating forming apparatus 32 will now be described. First, the disk cutters 2 are preliminarily washed before loading them into the chamber 34. Thereafter, the disk cutters 2 are placed on the table 38 with the spacers 40 alternately interposed, and the table 38 is next loaded into the chamber 34. The vacuum pump 36 is next driven to evacuate the chamber 34, and the heating means (not shown) is also operated to heat the inside of the chamber 34. The gas introducing means 50 is next driven to introduce an etching gas such as Ar gas, and an etching device (not shown) is then operated to perform etching using Ar ions, thereby removing an oxide film on the surface of each disk cutter 2.

After performing the etching, a bias voltage of 0 to −150 V is applied to the table 38 by the bias power supply 39. First, Ti ions are generated and supplied from the first evaporation source 42 having the Ti target 44 to perform ion plating, thereby forming the TiN layer 28 having a predetermined thickness on the outer circumferential portion of each disk cutter 2. Secondly, Ti ions and Al ions are simultaneously generated and supplied from the second evaporation source 46 having the TiAl target 48 to perform ion plating, thereby forming the TiAlN layer 30 on the TiN layer 28. In this manner, the first evaporation source 42 and the second evaporation source 46 are alternately operated to thereby alternately stack the TiN layers 28 and the TiAlN layers 30 on the outer circumferential portion of each disk cutter 2 including the tip inserts 14 and 14A, thus forming the TiAlN—TiN coating 15a having a thickness of 1 to 5 μm, preferably 2 to 3.5 μm.

After forming the TiAlN—TiN coating 15a, N₂ gas or He gas, for example, is introduced into the chamber 34 to cool the inside thereof. Thereafter, the table 38 is removed from the chamber 34, and all the disk cutters 2 are then removed from the table 38. Although not shown, a coating forming apparatus similar to the coating forming apparatus 32 shown in FIG. 7 is used to form the TiAlN coating 15 shown in FIG. 5. In this case, only the second evaporation source 46 having the TiAl target 48 is operated.

A life test was conducted on the disk cutter 2 having the TiAlN coating 15 on the tip insert according to the first preferred embodiment by mounting the disk cutter 2 on a rotary tool and rotating the disk cutter 2 at 60 to 70 rpm to cut a work material with a feed per tooth of 0.04 to 0.05 mm. As the work material was used austenitic stainless steel subjected to solution heat treatment, annealed ferritic stainless steel, or annealed martensitic stainless steel. A round bar having a diameter of 32 mm was used for the work material.

A similar life test was also made on a conventional disk cutter not having the coating 15 or 15a on the surface of the tip insert according to the present invention. As the test results, the life of the conventional disk cutter was 10,000 to 12,000 cuts. To the contrary, the life of the disk cutter 2 according to the first preferred embodiment was greatly extended to 37,000 to 47,000 cuts. A similar long life could also be obtained in the disk cutter having the TiAlN—TiN coating 15a according to the second preferred embodiment.

The present invention is not limited to the details of the above described preferred embodiments. The scope of the invention is defined by the appended claims and all changes and modifications as fall within the equivalence of the scope of the claims are therefore to be embraced by the invention.

What is claimed is:

1. A disk cutter comprising:
an annular disk-shaped base adapted to be driven about an axis of rotation;
a plurality of tip supports formed along the outer circumference of said base integrally therewith so that a gullet is defined between adjacent ones of said tip supports;
a plurality of tip inserts respectively fixed to said tip supports; and
a TiAlN coating formed on the surface of each tip insert;
each tip insert being formed of a sintered alloy composed of 98 to 90 w % of WC powder having a particle size of 0.1 to 0.8 μm and 2 to 10 w % of Co powder;
said TiAlN coating having a thickness of 0.5 to 5 μm.

2. The disk cutter according to claim 1, wherein said TiAlN coating has a thickness of 2 to 3.5 μm.

3. A disk cutter comprising:
an annular disk-shaped base adapted to be driven about an axis of rotation;
a plurality of tip supports formed along the outer circumference of said base integrally therewith so that a gullet is defined between adjacent ones of said tip supports;
a plurality of tip inserts respectively fixed to said tip supports; and
a TiAlN—TiN coating formed on the surface of each tip insert;
each tip insert being formed of a sintered alloy composed of 98 to 90 w % of WC powder having a particle size of 0.1 to 0.8 μm and 2 to 10 w % of Co powder;
said TiAlN—TiN coating being formed by alternately stacking TiN layers and TiAlN layers and having a thickness of 0.5 to 5 μm.

4. The disk cutter according to claim 3, wherein said TiAlN—TiN coating has a thickness of 2 to 3.5 μm.
